(19) United States
(12) Patent Application Publication
(10) Pub. No.: US 2019/0213130 A1
(43) Pub. Date: Jul. 11, 2019

(54) EFFICIENT SECTOR PREFETCHING FOR MEMORY SIDE SECTORED CACHE

(71) Applicant: Intel Corporation, Santa Clara, CA (US)

(72) Inventors: Srinivas Santosh Kumar Madugula, Visakhapatnam (IN); Supratik Majumder, Bangalore (IN)

(73) Assignee: Intel Corporation, Santa Clara, CA (US)

(21) Appl. No.: 15/863,854

(22) Filed: Jan. 5, 2018

(51) Int. Cl. G06F 12/0862; G06F 12/0811; G06F 12/0895; G06F 12/1045

(52) U.S. Cl. CPC G06F 12/0862; G06F 12/1045; G06F 12/0895; G06F 12/0811

(57) ABSTRACT

In one embodiment, a processor comprises a prefetcher comprising a plurality of trackers, a tracker of the plurality of trackers to store a prefetch mask to indicate which cache lines of a sector of a sectored cache have been prefetched from a system memory to the sectored cache; and a prefetch issuer comprising circuitry, the prefetch issuer to generate a prefetch request to prefetch cache lines of the sector of the sectored cache from the system memory into the sectored cache based on a prefetch confidence metric associated with the sector of the sectored cache.

### FIELD

The present disclosure relates in general to the field of computer development, and more specifically, to data prefetching.

### BACKGROUND

A computing system may include one or more processors, one or more memory devices, one or more input/output (I/O) controllers, one or more I/O devices, one or more caches, one or more cache controllers, and/or other components. A computing system may prefetch data to enhance operation of the computing system.

### BRIEF DESCRIPTION OF THE DRAWINGS

FIG. 1 is a block diagram of a computing system comprising a memory side sector prefetcher in accordance with certain embodiments;

FIG. 2 is a block diagram of a memory side sectored cache in accordance with certain embodiments;

FIG. 3 is a block diagram of a memory side sector prefetcher in accordance with certain embodiments;

FIG. 4 is a flow for processing a read request at a memory side sector prefetcher in accordance with certain embodiments;

FIG. 5 is a flow for issuing prefetches by a memory side sector prefetcher in accordance with certain embodiments;

FIG. 6 is a block diagram of a computing system in accordance with certain embodiments;

FIG. 7A is a block diagram illustrating both an exemplary in-order pipeline and an exemplary register renaming, out-of-order issue/execution pipeline in accordance with certain embodiments;

FIG. 7B is a block diagram illustrating both an exemplary embodiment of an in-order architecture core and an exemplary register renaming, out-of-order issue/execution architecture core to be included in a processor in accordance with certain embodiments;

FIGS. 8A-B illustrate a block diagram of a more specific exemplary in-order core architecture, which core would be one of several logic blocks (potentially including other cores of the same type and/or different types) in a chip in accordance with certain embodiments;

FIG. 9 is a block diagram of a processor that may have more than one core, may have an integrated memory controller, and may have integrated graphics in accordance with certain embodiments;

FIGS. 10, 11, 12, and 13 are block diagrams of exemplary computer architectures in accordance with certain embodiments; and

FIG. 14 is a block diagram contrasting the use of a software instruction converter to convert binary instructions in a source instruction set to binary instructions in a target instruction set in accordance with certain embodiments.

The figures below detail exemplary architectures and systems to implement embodiments of the above. In some embodiments, one or more hardware components and/or instructions described above are emulated as detailed below, or implemented as software modules.

Like reference numbers and designations in the various drawings indicate like elements.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to specific integrated circuits, such as computing platforms or microprocessors, other embodiments are applicable to other types of integrated circuits and logic devices. Similar techniques and teachings of embodiments described herein may be applied to other types of circuits or semiconductor devices. For example, the disclosed embodiments may be used in various devices, such as server computer systems, desktop computer systems, handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatuses, methods, and systems described herein are not limited to physical computing devices, but may also relate to software optimizations for energy conservation and efficiency.

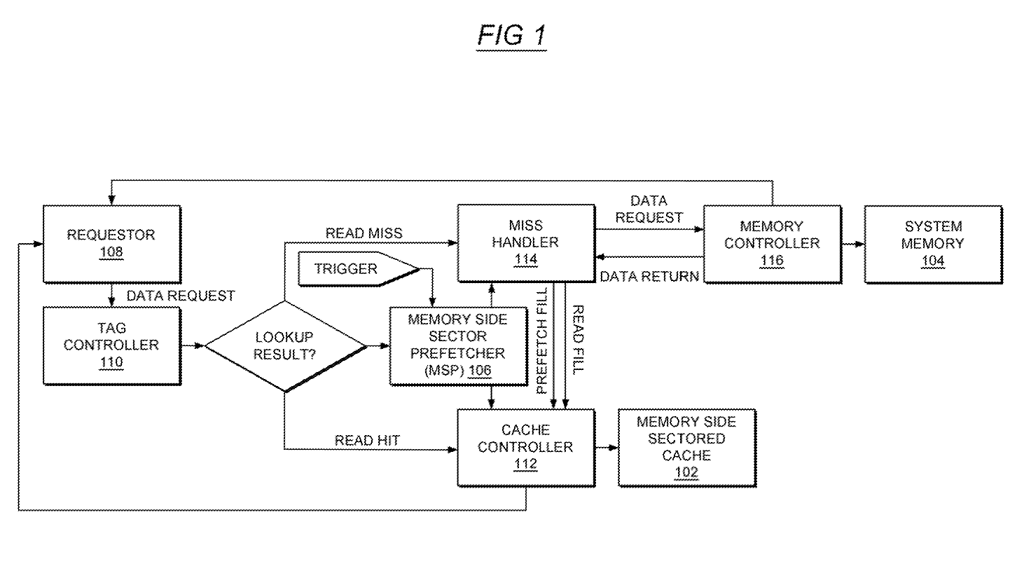

FIG. 1 is a block diagram of a computing system 100 comprising a memory side sector prefetcher 106 in accordance with certain embodiments. In addition to prefetcher 106, computing system 100 includes a memory side sectored cache 102 to cache data stored in system memory 104. Computing system 100 also includes a requestor 108 to request data, a tag controller 110, a cache controller 112, a miss handler 114, and a memory controller 116.

Cache prefetches play a critical role in reducing the negative impact of data latency of the memory subsystem on Central Processing Unit (or other processor) performance. CPU prefetchers balance a trade-off between cache size, prefetch aggression, and memory bandwidth at various levels of cache. Over-aggression can lead to cache thrashing and increased memory bandwidth utilization, resulting in a negative impact on performance, while under-aggression may leave performance gains unrealized. For modularity reasons, CPU prefetchers are generally only aware of caches within the CPU coherent fabric, but not of caches beyond the CPU coherent fabric (e.g., a memory side cache such as cache 102).

Large in-package memory solutions such as embedded dynamic random access memory (EDRAM) and High Bandwidth Memory (HBM) have become an integral part of client/server high performance CPUs due to reduced access latency and/or increased bandwidth compared to standard system memory. Caches employing such memory are typically sectored caches and provide a unique advantage for sector prefetching while avoiding or mitigating cache thrashing. Various embodiments of the present disclosure include a memory side sector prefetcher that utilizes information relating to pressure on the system memory and sector utilization to strategically issue prefetches for a memory side sectored cache without exposing the memory side sectored cache to the CPU prefetchers (i.e., the CPU prefetchers may operate in the same manner as they would if the memory side sector prefetcher were not present).

A memory side cache and supporting logic may be implemented in various manners. In one example architecture, data is never prefetched into the memory side cache. Rather, cache lines within a sector (sometimes referred to as a superfine) are only filled in the memory side cache on a read or write miss. However, such an architecture which doesn't take advantage of prefetching misses an opportunity to significantly reduce the data latency of such requests by retrieving prefetched data from the memory side cache. In another architecture, all of the cache lines of a sector may be prefetched in response to a read or write miss on a cache line of the sector. However, such an architecture may place undue strain on system memory bandwidth, especially in use cases with low sector utilization. Another example architecture may include a CPU prefetcher that is aware of the memory side cache (and may adjust its operation accordingly), however such architectures are not conducive to modularity and scalability.

Particular embodiments of the present disclosure include a memory bandwidth aware prefetcher for a memory side sectored cache with one or more CPU prefetchers that operate in the same manner whether the memory side sectored cache is present or not (i.e., the CPU prefetchers may be unaware of the existence of such a cache). By incorporating a memory side prefetcher without exposing the memory side sectored cache to CPU prefetchers, read access latency to the memory sub-system may be reduced while preserving the modularity of the CPU prefetchers.

A particular embodiment includes a stream/stride prefetcher for a sectored cache to prefetch based on sector utilization and a trigger mechanism to guard against a negative impact on memory bandwidth due to prefetching. A particular embodiment may utilize a trigger mechanism to throttle prefetching based on a memory pressure counter to estimate overall memory pressure caused by misses and evictions from the memory side cache. Another embodiment may utilize a trigger mechanism to throttle prefetching based on a read pending queue occupancy of the system memory. Unlike a CPU prefetcher, the aggression of a memory side prefetcher can be controlled through direct feedback from the system memory due to its proximity to the system memory through the trigger mechanisms described herein. In some embodiments, a prefetcher may utilize a park counter to increase memory locality or reduce sector interleaving at memory due to prefetching.

The memory side sectored cache 102 may cache data stored by system memory 104. System memory 104 stores instructions and/or data that are to be interpreted, executed, and/or otherwise used by requestor 108. In a particular embodiment, system memory 104 may cache data of a storage device, such as a hard disk drive or other storage medium. The system memory 104 may have a dual-inline memory module (DIMM) form factor or other suitable form factor.

The system memory 104 may include any type of volatile and/or non-volatile memory. Non-volatile memory is a storage medium that does not require power to maintain the state of data stored by the medium. Nonlimiting examples of non-volatile memory may include any or a combination of: solid state memory (such as planar or 3D NAND flash memory or NOR flash memory), 3D crosspoint memory, byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), a memristor, phase change memory, Spin Hall Effect Magnetic RAM (SHE-MRAM), Spin Transfer Torque Magnetic RAM (STTRAM), or other non-volatile memory devices.

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory array is synchronous dynamic random access memory (SDRAM). In some embodiments, any portion of system memory 104 that is volatile memory can comply with JEDEC standards including but not limited to Double Data Rate (DDR) standards, e.g., DDR3, 4, and 5, or Low Power DDR4 (LPDDR4) as well as emerging standards.

Memory controller 116 may be an integrated memory controller (e.g., it may be integrated on the same die or integrated circuit as the requestor 108) that includes circuitry to control the flow of data going to and from system memory 104. In some embodiments, memory controller 116 may be implemented on a different die or integrated circuit than that of the requestor 108. Memory controller 116 may include circuitry operable to read from a system memory 104, write to a system memory 104, or to request other operations from a system memory 104. In various embodiments, memory controller 116 may receive write requests originating from a core or an I/O controller and may provide data specified in these requests to a system memory 104 for storage therein. Memory controller 116 may also read data from system memory 104 and provide the read data to the requestor 108 and/or the miss handler 114 (which may provide the data to cache controller 112 to store the data in the memory side sectored cache 102). During operation, memory controller 116 may issue commands including one or more addresses (e.g., row and/or column addresses) of the system memory 104 in order to read data from or write data to memory (or to perform other operations).

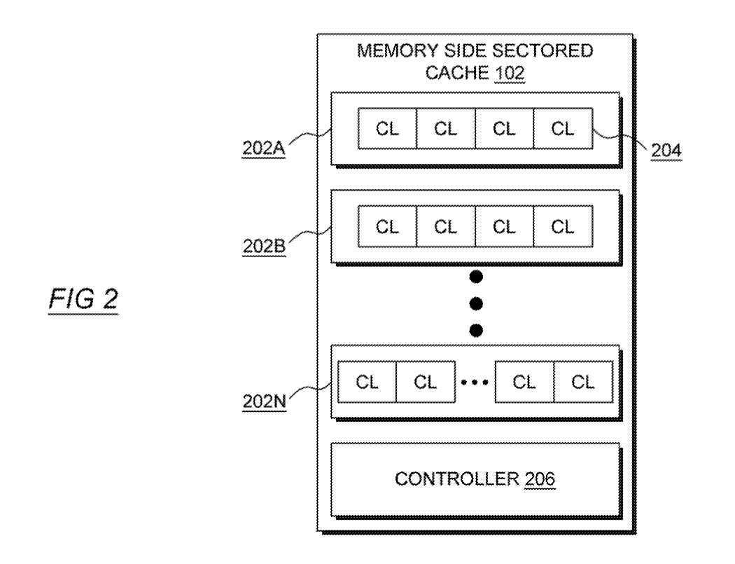

FIG. 2 is a block diagram of a memory side sectored cache 102 in accordance with certain embodiments. The memory side cache may cache data that is stored in system memory 104. In a particular embodiment, the cache 102 is located between a last level cache (LLC) of the requestor 108 and the system memory 104. For example, after the requestor 108 determines that data is not stored in a cache in the cache coherent domain of the requestor, the requestor 108 may send a request towards system memory 104 for the data (in various embodiments, the requestor 108 does not track the contents of the memory side sectored cache 102 and may not even be aware of its existence). Before the data is requested from system memory 104, a determination may be made (e.g., by tag controller 110) to determine whether the memory side sectored cache 102 has a valid copy of the requested data (and the data may be returned from the cache 102 to the requestor 108 without sending a request to system memory 104 if the data is present and valid in the cache 102).

In the embodiment depicted, cache 102 is a sectored cache. A sectored cache is organized into sectors (e.g., sector 202A, sector 202B, etc.), sometimes referred to as superliner. Each sector may be any suitable size (e.g., 1 KB) and may include any suitable number of contiguous cache lines 204, such as 16, 32, 64, etc. Each cache line 204 may comprise any suitable amount of data, such as 32 bytes, 64 bytes, 128 bytes, etc. The cache 102 may be any suitable size, such as 64 megabytes (MB), 96 MB, 128 MB, or other suitable size. In a particular embodiment, the cache 102 is larger than a largest cache (e.g., an LLC) of the requestor 108 and smaller than system memory 104.

Cache 102 may be implemented as a sector cache to reduce the size of a tag used to access cache lines. In one embodiment, a sector has a size of 1 KB and includes 16 consecutive 64-byte cache lines. In such an embodiment, the tag size may be reduced by a factor of 16 compared to a non-sectored design.

Each of the cache lines may be identified by a memory address. In various embodiments, a portion of a memory address may identify a particular sector and another portion of the memory address may identify a cache line within that sector. In various embodiments, the memory address may refer to the same cache line within system memory 104 and sectored cache 102.

In a particular embodiment, when a portion of cache 102 is allocated for new data (e.g., when old data is evicted), the allocation may be done at the sector level (i.e., an entire sector may be allocated) while the transfer of data from the system memory 104 to the cache 102 may have any suitable granularity. For example, when data is retrieved from system memory 104 and stored in cache 102, the data may be copied to the memory side sectored cache 102 one cache line at a time or multiple contiguous cache lines at a time. Because the cache 102 may be filled at a lower level of granularity than it is allocated, some cache lines of a sector may be valid (e.g., because they were recently filled) while others may be invalid, though at other times all cache lines of a sector may be invalid or all cache lines of a sector may be valid. In a particular embodiment, the age of the data (e.g., an indication of the length of time since the data was accessed) of a sector is maintained on a per-sector basis (thus all cache lines of a particular sector may have the same age).

In various embodiments, cache 102 is located on the same die and/or semiconductor package as the requestor 108, though in other embodiments, the cache 102 is located on a different die and/or semiconductor package. In a particular embodiment, the cache 102 is in the same package as the requestor 108, but on a different die. In a particular embodiment, multiple requestors (e.g., each located on its own die or collocated on a die) may share the same cache 102.

The cache 102 may include any type of volatile and/or non-volatile memory, such as any of the memory types described above or other suitable memory types. As a few examples, the cache 102 may comprise EDRAM, DRAM, or HBM.

Cache 102 may also comprise a controller 206 to interface with the cache controller 112. Controller 206 may control read, write, and other operations performed on the sectors 202 and cache lines 204 of the cache 102.

Referring again to FIG. 1, cache controller 112 includes circuitry to control the flow of data going to and from cache 102. In a particular embodiment, cache controller 112 is an integrated controller (e.g., it may be integrated on the same die or integrated circuit as the requestor 108 and/or the memory controller 116). In other embodiments, cache controller 112 may be implemented on a different die or integrated circuit than that of the requestor 108 and/or the memory controller 116. In a particular embodiment, the cache controller 112 is located on the same die as the memory side sectored cache 102, though in another embodiment the cache controller 112 may be located on a different die. In various embodiments, the cache controller 112 may be distinct from the memory controller 116 or may be integrated within the memory controller 116.

Cache controller 112 may include circuitry operable to read from a memory side sectored cache 102, write to a memory side sectored cache 102, or to request other operations from a memory side sectored cache 102. In various embodiments, cache controller 112 may receive write requests originating from requestor 108 and may provide data specified in these requests to a memory side sectored cache 102 for storage therein. Cache controller 112 may also receive read data from system memory 104 (e.g., via miss handler 114 and/or memory controller 116) and cache the read data. Cache controller 112 may also receive prefetched data from system memory 104 (e.g., via miss handler 114 and/or memory controller 116) and cache the prefetched data. When a data request is received from requestor 108, if a determination is made (e.g., by tag controller 110), that the requested data is located in the cache 102, the request may be sent to the cache controller 112 which may retrieve the data from the cache 102 and provide the data to the requestor 108. During operation, cache controller 112 may issue commands including a sector and/or one or more cache line addresses of the cache 102 to the cache 102 in order to read data from or write data to the cache (or to perform other operations).

Requestor 108 may comprise any suitable entity operable to request data from system memory 104. As various examples, requestor 108 may be or comprise a processor or portion thereof, a processor core, a CPU or portion thereof, a graphics processing unit or portion thereof, a display unit or portion thereof, an I/O device controller, or other suitable computing logic comprising circuitry.

In addition to various components, FIG. 1 depicts an example flow for a data request issued by the requestor 108. The requestor 108 may issue any suitable data request. For example, the data request may be a request to read data or prefetch data (e.g., the data request may have been issued by a prefetcher of the requestor, such as a CPU prefetcher, to prefetch data into a cache of the requestor, such as a last level cache or other lower level cache). The request is sent by the requestor 108 to the tag controller 110.

An incoming request may include information identifying a cache line. For example, the incoming request may include an address of a cache line of system memory 104. In a particular embodiment, the address may include a portion that maps to a sector of cache 102 and a portion that maps to a cache line within that sector. The same address may also map to a cache line within system memory 104. The tag controller 110 may maintain a plurality of tags that each correspond to a sector of the cache 102. For each tag, the tag controller may maintain a record of the cache lines that are valid for the sector of cache 102 that corresponds to the tag. For example, each tag may be associated with a valid cache line (CL) mask which includes indications of which cache lines in the sector corresponding to the tag are valid in the cache 102 (for example, the mask may include a bit for each cache line and the value of the bit indicates whether the corresponding cache line is valid or not). When an incoming request is received, the tag controller 110 may determine whether a portion of the address of the request matches a tag (indicating a sector hit) and whether the appropriate bit (corresponding to the requested cache line within the sector) of the associated valid CL mask is set (indicating a cache line hit). Thus, the lookup performed by the tag controller 110 will indicate whether the requested cache line is a sector hit or miss and a cache line hit or miss. If the lookup is a sector hit and a cache line hit, then the lookup is considered to result in a “read hit”, otherwise the lookup is considered to result in a “read miss.”

In the case of a read hit, a request for the cache line is sent to the cache controller 112 which retrieves the cache line from cache 102 and returns the data towards the requestor 108. In the case of a read sector miss, tag controller 110 will select a victim candidate sector from the sectors allocated in cache 102 and allocates a new sector in place of the victim candidate sector. The tag controller 110 may send a request to the miss handler 114 which then communicates with memory controller 116 to retrieve the cache line from system memory 104 (typically data is retrieved from system memory 104 one cache line at a time, though in particular embodiments multiple cache lines may be returned in response to a single request). The memory controller 116 then returns the data towards the requestor 108 and the data may also be filled in the cache 102.

In addition to sending data requests to the cache controller 112 (in the case of a read hit) and to the miss handler 114 (in the case of a read miss), the tag controller 110 may also send data requests or associated information thereof to the prefetcher 106 (in other embodiments, the data requests or associated information may be accessed by the prefetcher 106 in any other suitable manner). In various embodiments, the data request or associated information may include an identification of the sector requested and an identification of the cache line requested. In a particular embodiment, the data request sent to the prefetcher 106 may include any other suitable information such as a valid CL mask which includes indications of which cache lines in the requested sector are valid in the cache 102 (for example, the mask may include a bit for each cache line and the value of each bit may indicate whether the corresponding cache line is valid or not). In a particular embodiment, the data request or associated information sent to the prefetcher 106 includes an indication of whether there was a hit in the cache 102 for the requested sector and whether there was a hit in the cache 102 for the requested cache line.

Miss handler 114 may maintain a queue of requests to be sent to the system memory. The requests may be requests from the requestor 108 (i.e., read or prefetch requests resulting from a miss in the memory side sectored cache 102) or a prefetch request from prefetcher 106. In a particular embodiment, requests received from the requestor 108 may be given higher priority than requests from prefetcher 106. In another embodiment, the requests may be given the same priority.

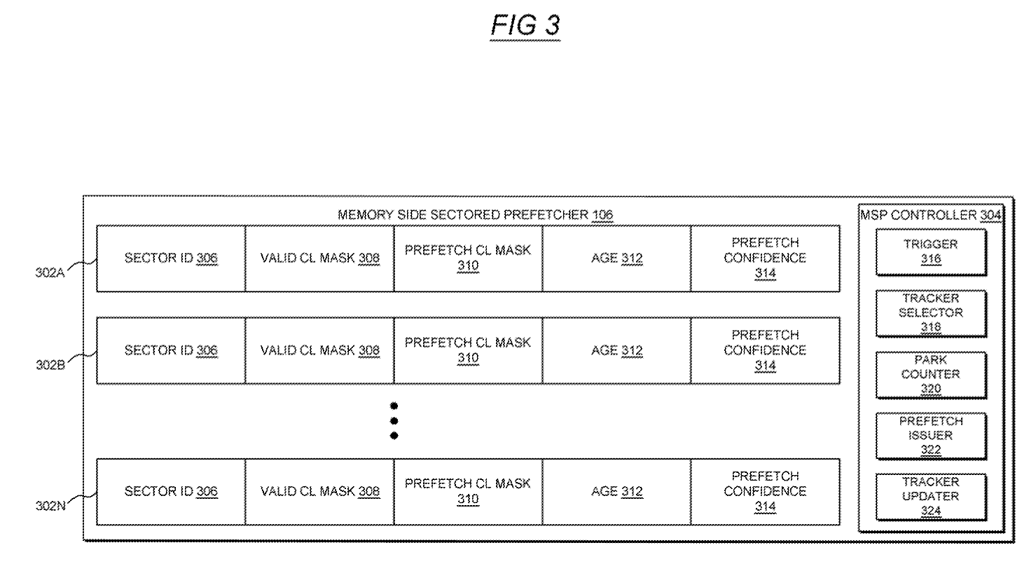

FIG. 3 is a block diagram of a memory side sector prefetcher 106 in accordance with certain embodiments. Prefetcher 106 includes a plurality of trackers 302A-N and an MSP controller 304 which includes trigger 316, tracker selector 318, park counter 320, prefetch issuer 322, and tracker updater 324.

Prefetcher 106 tracks the active sectors in cache 102 and issues prefetch requests for data of system memory 104 on behalf of cache 102 based on prefetch confidence and available memory bandwidth. In various embodiments, the prefetcher 106 tracks a particular number of sectors of data allocated in cache 102. That is, prefetcher 106 maintains a plurality of trackers 302A-N that each store information associated with a particular sector that is allocated in cache 102 (where a sector that is allocated may have a corresponding tag stored by tag controller 110). Any number of trackers 302 may be maintained by the prefetcher 106, such as 32, 48, 64, or other suitable number of trackers. In general, the number of trackers 302 (and corresponding sectors being tracked for prefetches) is much smaller than the number of sectors allocated in cache 102.

Active sectors (i.e., sectors that have been recently accessed) are tracked by the trackers. In a particular embodiment, only the sectors which are detected to have a threshold number of valid CLs in the memory side cache 102 are eligible for prefetch. In various embodiments, the prefetches are limited to the sectors that are currently active (by virtue of these sectors having associated trackers) where the prefetches are potentially useful and avoids prefetches to sectors with no near-term accesses. Often the accesses to the memory side cache 102 include prefetches from the requestor 108 (e.g., a CPU prefetcher) for lower levels of cache. Since stream/stride (or other types of) CPU prefetchers already predict the pattern/potential usefulness of the prefetch, having a simple tracker mechanism to predict such accesses ahead of time results in the detection of potentially useful prefetches. Also, limiting the number of sectors that are eligible for prefetch reduces or eliminates unnecessary prefetching for workloads with sparse sector accesses beyond the number of trackers.

Each tracker 302 may store data about the sector the tracker is tracking. In the embodiment depicted, each tracker stores a sector ID 306, a valid CL mask 308, a prefetch CL mask 310, an age 312, and a prefetch confidence 312. The sector ID 306 may include any suitable identifier of the sector, such as the sector address or an identifier based on the sector address. In a particular embodiment, the sector ID 306 is equal to the corresponding tag of the sector stored by tag controller 110.

Valid CL mask 308 stores indications of which cache lines of the sector are valid in the cache 102. As an example, valid CL mask 308 may include a series of bits with one bit for each cache line. The value of a bit may indicate whether the corresponding cache line is valid in the cache 102 or not. In a particular embodiment, valid CL mask 308 may mark a cache line as valid when it is inflight (i.e., currently being fetched from system memory 104) as well as committed (i.e., already filled in the cache 102). In some embodiments, a valid CL mask 308 may be updated by the tracker in response to receiving a data request or associated information from the tag controller 110, for example based on a valid CL mask included in and/or a cache line identified by the data request or associated information.

A prefetch CL mask 310 stores indications of which cache lines of the sector have been prefetched by the prefetcher 106. As an example, prefetch CL mask 310 may include a series of bits with one bit for each cache line. The value of a bit may indicate whether the corresponding cache line has been prefetched or not. When a tracker is allocated for a particular sector, the prefetch CL mask 310 may be reset (so as to indicate that none of the cache lines of the sector have been prefetched). The prefetch mask may be used in order to determine prefetch confidence 314 for the sector.

A tracker 302 may also store an age 312 of the tracker. The age 312 may provide an indication of how recently a cache line from the sector tracked by the tracker 302 was requested by the requestor 108. In a particular embodiment, the age may be reset when a request for any cache line of the corresponding sector is received. During periods of no accesses to the sector, the age of the tracker may increase. Any other suitable scheme may be used to update the age of the tracker to indicate how recently the sector has been accessed.

In other embodiments, trackers 302 may each store any other suitable information about the sector. As an example, a tracker 302 may store information about how often the sector has been accessed, an access pattern for cache lines of the sector, or any other suitable information associated with the corresponding sector.

Prefetch confidence 314 provides an indication of the likelihood of success for a prefetch issued for a cache line of the sector (i.e., how likely it is that the prefetched cache line will be requested by the requestor). In a particular embodiment, the prefetch confidence 314 may be increased each time a cache line that has been prefetched is requested by the requestor 108. For example, prefetch confidence 314 may be a value of a counter that is incremented each time any of the prefetched cache lines are requested. As another example, the prefetch confidence 314 may be a value of a counter that is incremented one time for each of the prefetched cache lines that are requested (and additional requests for the prefetched cache line do not increment the counter). As yet another example, the prefetch confidence 314 may increase responsive to accesses to cache lines of the sector regardless of whether the cache line has been prefetched or not. Any other suitable metrics indicating the likelihood of success of a prefetch for the sector may be used to determine the prefetch confidence 314.

Trigger 316 includes circuitry to selectively enable and disable prefetch requests in order to prevent or throttle prefetches generated by prefetcher 106 during periods of high memory bandwidth utilization. In a particular embodiment, the trigger is enabled when there is no other request to memory controller 116 in a given cycle (and otherwise is disabled such that no prefetch requests are issued by prefetcher 106). In some embodiments, prefetches are limited only to situations in which there is low pressure on the system memory 104.

In a particular embodiment, trigger 316 utilizes a memory pressure counter to determine when to allow prefetches to be issued by the prefetcher 106. For example, the memory pressure counter may be a low/high saturating pressure counter which increments in response to a data request (e.g., a read request and/or a prefetch request) being sent to system memory 104. The counter may be incremented in any suitable fashion. In a particular embodiment, the counter may increment in response to an access to system memory 104. In another embodiment, the counter may increment in response to a miss in the cache 102 (e.g., as detected by tag controller 110). In yet another embodiment, the counter may increment in response to an eviction from the cache 102.

In various embodiments, the counter may decrement at the rate of system memory bandwidth. For example, the counter may decrement once every N cycles, where N cycles is the number of clock cycles per each cache line returned from the system memory at peak rate (as opposed to the full round trip latency time for a cache line). In some embodiments, the rate at which the counter decrements may be adjusted to account for the actual memory bandwidth (e.g., because operation at peak rate is rare, the actual bandwidth may be, e.g., between 60-80% of the peak rate). Thus, a derating factor may be applied to the decrementation interval in order to slow the rate at which the counter decrements to account for the expected or actual memory bandwidth (in various embodiments, the memory bandwidth may be measured and the rate of decrementation of the memory pressure counter may be adjusted based on such measurements).

In a particular embodiment, the memory pressure counter is a signed counter. A value of zero for the counter may indicate that the number of accesses to system memory 104 matches the system memory bandwidth and a negative value indicates potential headroom in the system memory bandwidth to be used for prefetch requests.

In a particular embodiment, when the memory pressure counter reaches a particular threshold, issuance of prefetches may be disabled completely or throttled (i.e., the rate at which prefetches are allowed may be limited). In some embodiments, multiple thresholds may be used and as each threshold is crossed the rate at which prefetches are allowed to be issued by the prefetcher 106 may decrease. In a particular embodiment, the memory pressure counter is adjusted (e.g., halved) every M cycles for hysteresis where M is any suitable integer. Such adjustment may protect against issuing an inordinate amount of prefetches when the utilized memory bandwidth experiences a sudden change.

In another embodiment, trigger 316 utilizes a read pending queue occupancy to determine when to allow prefetches to be issued by the prefetcher 106. For example, memory controller 116 or miss handler 114 may include a read pending queue to hold the data requests for the system memory 104 before the data requests are scheduled to be sent to the system memory 104. The occupancy of this queue may indicate outstanding requests to system memory 102 and thus the amount of pressure on the system memory 104.

In a particular embodiment, when the read pending queue occupancy reaches a particular threshold, issuance of prefetches may be disabled completely or throttled (i.e., the rate at which prefetches are allowed may be limited). In some embodiments, multiple thresholds may be used for the read pending queue occupancy and as each threshold is crossed the rate at which prefetches from the prefetcher 106 are allowed to be issued may decrease.

Tracker selector 318 selects a tracker 302 corresponding to a sector from which one or more prefetches are to be issued. After one or more prefetches have been issued for one or more cache lines from the selected tracker, tracker selector 318 may select a new tracker and one or more prefetches may be issued from the corresponding tracker. Tracker selector 318 may use any suitable criteria to select a tracker. For example, tracker selector 318 may select a tracker with the highest prefetch confidence of all of the trackers. As another example, tracker selector 318 may select the most recently used tracker.

Park counter 320 may be used to control the number of consecutive prefetches that are issued for a sector corresponding to the tracker selected by the tracker selector 318 before a new tracker is selected and prefetches are issued for the corresponding sector. The park counter 320 may increment or decrement each time a cache line is prefetched from the tracker corresponding to the selected sector. Once a threshold value of the counter is reached (i.e., the counter expires), the counter may be reset and the tracker selector 318 may select a different tracker. Thus, park counter 320 may enable parking on a given sector tracker for a certain number of prefetches before moving on to the next active tracker. Depending on the memory structure of system memory 104, use of the park counter may increase memory locality or reduce sector interleaving due to prefetch.

The park counter 320 may be configured to allow any suitable number of consecutive prefetches for a sector. For example, the park counter may be configured to two, four, or other suitable value. In various embodiments, the park counter may be optimized based on the desired memory locality and the manner in which memory addresses map to physical structures in the system memory 104. In a particular embodiment, the threshold value of the counter may be configurable. As just one example, the value of the counter may be a BIOS setting that is reconfigurable.

The prefetch issuer 322 may issue prefetch requests for cache lines of sectors that are being tracked by the trackers 302. In at least some embodiments, prefetcher 106 does not issue prefetch requests for cache lines of sectors that do not have a corresponding tracker 302. The prefetch issuer 322 may issue prefetch requests for the sectors in any particular order and may issue prefetch requests for any number of cache lines of the sector (in some embodiments, the prefetch issuer does not issue prefetches for all or a portion of the cache lines that are not already stored in the cache 102). In various embodiments, the prefetch issuer 322 may issue prefetch requests so as to implement any suitable prefetcher, such as a stream prefetcher, a stride prefetcher, a spatial prefetcher (e.g., an adjacent line prefetcher), an access map pattern matching prefetcher, a feedback directed prefetcher, a sandbox prefetcher, a spatial memory streaming prefetcher, or other suitable prefetcher. In a particular embodiment, for each sector, the prefetch issuer 322 prefetches cache lines that are not already in the cache 102 (e.g., as indicated by the valid CL mask 310) in order of increasing cache line address.

Any suitable data may be prefetched by prefetcher 106, such as instructions to be executed by requestor 108 or data to be used (e.g., as an operand) during execution of an instruction by requestor 108. Prefetching data into cache 102 may include requesting that data be placed into the memory side cache 102 prior to (e.g., in anticipation of) a request for the data being received at the cache 102 from requestor 108.

Tracker updater 324 may perform any suitable updates to the trackers. For example, tracker updater 324 may update prefetch confidence metrics associated with sectors according to any methodology described herein.

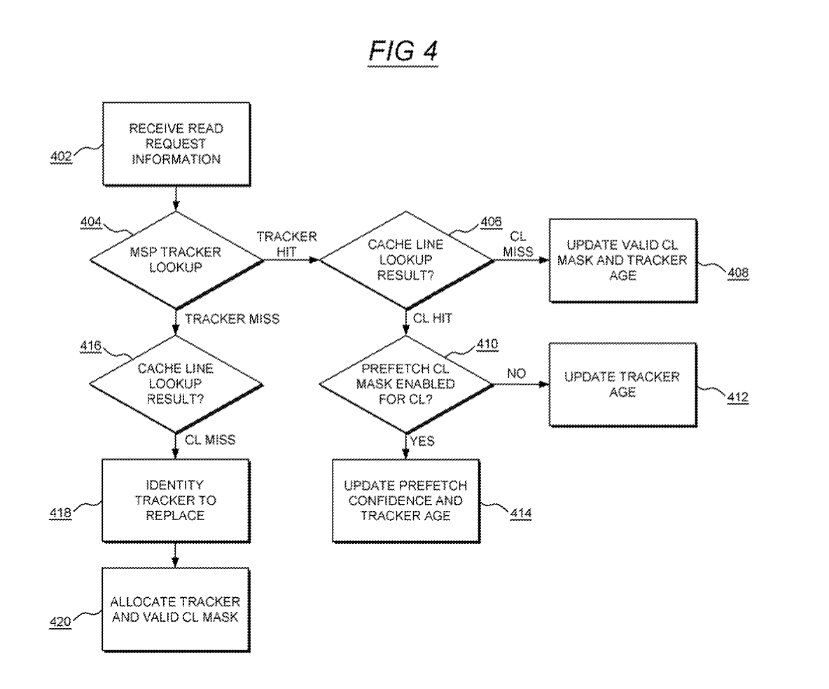

FIG. 4 is a control flow for processing a read request at a memory side sector prefetcher 106 in accordance with certain embodiments. At 402, information associated with a read request is received (e.g., from tag controller 110). Any suitable information may be received, such as an identification (e.g., address) of the sector requested, an identification (e.g., address) of the cache line requested, an indication of whether the sector is located in the cache 102, an indication of whether a valid version of the requested cache line is located in the cache 102, a valid CL mask for the requested sector, and/or any other suitable information associated with the read request from the requestor 108.

At 404, the prefetcher 106 performs a lookup of a tracker based on an identifier of the sector of the cache line requested by requestor 108. If the prefetcher 106 includes a tracker corresponding to the sector (i.e., if the prefetcher 106 is tracking the sector), the flow moves to 406.

At 406 a determination is made as to whether a valid copy of the cache line is in the cache 102. In a particular embodiment, the read request information received at 402 includes an explicit indication of whether the cache line is located in the cache 102. In another embodiment, the prefetcher 106 may check an identification of the requested cache line against the valid CL mask 308 of the tracker to determine whether a cache line miss or hit has occurred.

In the case of a cache line miss, the flow moves to 408. At 408, the valid CL mask 308 is updated to reflect the request that will be made to the system memory 106 as a result of the CL miss. That is, because the tag controller 110 will request the cache line in response to determining that the cache line is not located in the cache 102, the valid CL mask 308 of the tracker may be updated to indicate that the cache line is valid in the cache 102. At 408, the age 312 of the tracker is updated (e.g., reset) to reflect that the sector has been recently accessed.

In the case of a cache line hit, the flow moves to 410. At 410, a determination is made as to whether the prefetch CL mask 310 is enabled for the requested cache line. For example, a bit of the prefetch CL mask 310 that corresponds to the cache line may be checked to determine whether it is set. If the bit is not set, then the prefetch CL mask is not enabled for the cache line. In that case, the flow moves to 412, where the age of the tracker is updated.

However, when the prefetch CL mask is enabled for the cache line (indicating that this cache line was previously prefetched), the prefetch confidence for the tracker is updated. For example, the prefetch confidence may be increased because a cache line that was previously prefetched has been requested by the requestor 108. In a particular embodiment, the prefetch confidence is tracked by a counter that is incremented each time a line that has previously been prefetched by prefetcher 106 is accessed. The tracker age may also be updated at 414.

If the lookup at 404 indicates that the prefetcher 106 is not tracking the requested sector (i.e., in the case of tracker miss), a determination is made as to whether the cache line lookup result was a hit or a miss at 416. If the result was a cache line miss, the flow moves to 418. At 418, a tracker to replace is identified. That is, prefetcher 106 stops tracking the sector corresponding to the tracker to be replaced. The tracker to replace may be determined in any suitable manner. For example, the tracker corresponding to the least recently accessed sector may be identified. As another example, the tracker of the sector that is accessed least frequently of all of the tracked sectors may be identified. As another example, if a sector already has all cache lines stored in the cache, the corresponding tracker may be identified. In other embodiments, any suitable tracker may be identified for replacement.

At 420, a tracker is allocated for the sector of the cache line that was requested by requestor 108. In some embodiments, various information of the tracker may be reset (since this information corresponds to the sector previously being tracked) or otherwise updated. For example, the sector ID 306 may be updated to correspond to the new sector being tracked. The valid CL mask may be updated to match a valid CL mask sent from the tag controller 110 (or otherwise provided to the prefetcher 106). The prefetch CL mask 310 may be reset to reflect that no cache lines of the sector have been prefetched yet. The age 312 and prefetch confidence 314 may be reset.

In a particular embodiment, in the event of a tracker miss and a CL hit at 416, no action is taken with respect to allocation of a tracker for the sector of the requested cache line. This is because the request may be for a sector having cache lines which are already all stored in the cache (e.g., because all of the lines were prefetched or otherwise requested).

The flow depicted focuses on the prefetcher 106. As described above, other actions may be performed by a computing system in response to a cache line miss or hit (e.g., the data may be returned to the requestor 108 and/or requested from system memory 104).

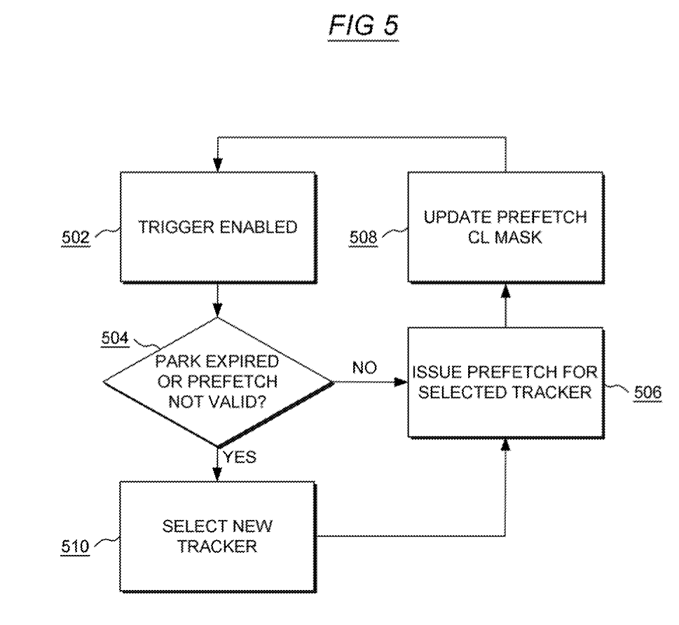

FIG. 5 is a control flow for issuing prefetches by a memory side sector prefetcher 106 in accordance with certain embodiments. The flow assumes that a particular tracker has been selected by the prefetcher. At 502, trigger 316 is enabled based on a metric indicating a utilization level of system memory 104. For example, as described above the enablement of the trigger may be based on a counter, a queue occupancy, or any other suitable metric indicating how much bandwidth is available to prefetch data from the system memory 104.

At 504, a determination is made as to whether the park counter is expired and whether a prefetch is valid for the sector. As an example, if all cache lines of the sector are already located in the cache 102, a prefetch for that sector is not needed and the prefetch may be considered invalid. As another example, if the particular prefetcher implemented indicates that no additional prefetching is to be performed for the sector (even if all of the cache lines of the sector are not present in the cache), the prefetch may be considered invalid.

If the park counter is not expired and at least one valid prefetch remains for the sector, a prefetch is issued for the selected tracker (e.g., a cache line of the sector corresponding to the tracker is prefetched) at 506. At 508, the prefetch CL mask of the tracker is updated so as to reflect that the cache line has been prefetched. In some embodiments, the valid CL mask may also be updated to indicate that the prefetched cache line is now stored in the cache 102 (to prevent an additional prefetch request for the cache line from being generated). The flow then returns to 502.

If the park counter is expired or no valid prefetches remain for the sector, the flow moves to 510. At 510, a new tracker is selected. The new tracker may be selected based on any suitable criteria. In a particular embodiment, the most recently used tracker (e.g., as indicated by the age of the tracker) is selected. In an embodiment, the tracker with the highest prefetch confidence value is selected. In one embodiment, the tracker with the highest prefetch confidence value is selected when at least one tracker has a prefetch confidence above a particular threshold. In a particular embodiment, if no tracker has a prefetch confidence value above a particular threshold, then the most recently used tracker is selected. Any other suitable method may be used to select the new tracker. In various embodiments, trackers without valid prefetches are excluded from the selection. When a new tracker is selected the park counter may also be reset.

The flow then moves to 506 where a prefetch request is issued for a cache line of the new sector. The cache lines may be prefetched in any suitable order as determined by the type of prefetcher implemented. In a particular embodiment, the lowest addressed cache line that is not yet in the cache 102 is prefetched. In other embodiments, a detected access pattern (e.g., forwards, backwards, every other, etc.) of the cache lines of the sector may be used to select the next cache line to be prefetched.

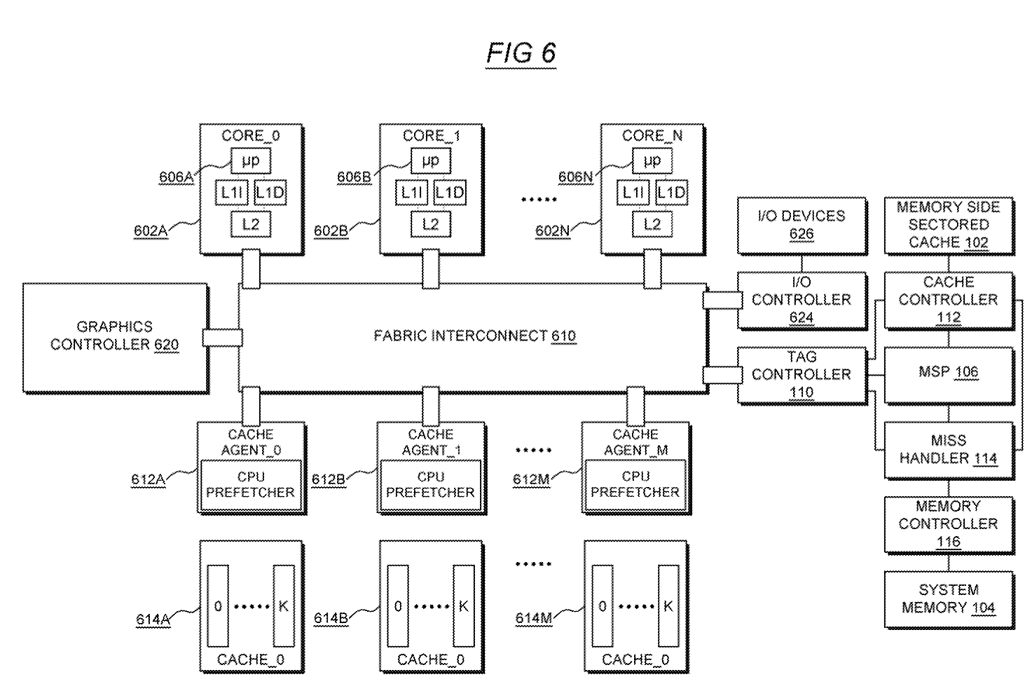

FIG. 6 is a block diagram of a computing system 600 in accordance with certain embodiments. System 600 comprises a plurality of cache agents 612 (i.e., cache agents 612A-612M) and caches 614 (i.e., caches 614A-614M) in accordance with certain embodiments. In a particular embodiment, system 600 may be a single integrated circuit, though it is not limited thereto. The system 600 may be a system on a chip or a portion thereof in various embodiments.

System 600 may comprise any type of processor, including a general purpose microprocessor, special purpose processor, microcontroller, coprocessor, graphics processor, accelerator, field programmable gate array (FPGA), or other type of processor (e.g., any processor described herein). The processor may include multiple threads and multiple execution cores, in any combination. In one embodiment, the processor is integrated in a single integrated circuit die having multiple hardware functional units (hereafter referred to as a multi-core system). The multi-core system may be a multi-core processor package, but may include other types of functional units in addition to processor cores. Functional hardware units may include processor cores, digital signal processors (DSP), image signal processors (ISP), graphics cores (also referred to as graphics units), voltage regulator (VR) phases, input/output (I/O) interfaces (e.g., serial links, DDR memory channels) and associated controllers, network controllers, fabric controllers, or any combination thereof.

The processor may include, for example, one or more cores 602A, 602B . . . 602N. In a particular embodiment, the cores may each include a corresponding microprocessor 606A, 606B, or 606N, level one instruction (L1I) cache, level one data cache (L1D), and level two (L2) cache. The processor may further include one or more cache agents 612A, 612B, . . . 612M (any of these cache agents may be referred to herein as cache agent 612), and corresponding caches 614A, 614B, . . . 614M (any of these caches may be referred to as cache 614). In a particular embodiment, a cache 614 is a last level cache (LLC) slice. An LLC may be made up of any suitable number of LLC slices. Each cache may include one or more banks of memory to store data that corresponds to (e.g., duplicates) data stored in system memory 104. The processor may further include a fabric interconnect 610 comprising a communications bus (e.g., a ring or mesh network) through which the various components of the processor connect. In one embodiment, the processor further includes a graphics controller 620, an I/O controller 624, and a memory controller 116. The I/O controller 624 may couple various I/O devices 626 to components of the processor through the fabric interconnect 610.

A cache (e.g., cache 614, an L1 cache, an L2 cache, or other cache described herein) may include any type of volatile or non-volatile memory, including any of those listed above. The processor is shown as having a multi-level cache architecture. In one embodiment, the cache architecture includes an on-die or on-package L1 and L2 cache and an on-die or on-chip LLC (though in other embodiments the LLC may be off-die or off-chip) which may be shared among the cores 602A, 602B, . . . 602N, where requests from the cores are routed through the fabric interconnect 610 to a particular LLC slice (i.e., a particular cache 614) based on request address. Any number of cache configurations and cache sizes are contemplated. Depending on the architecture, the cache may be a single internal cache located on an integrated circuit or may be multiple levels of internal caches on the integrated circuit. Other embodiments include a combination of both internal and external caches depending on particular embodiments.

In other embodiments, the cache architecture may include additional levels of cache, such as L3, L4, and so on. Any cache (e.g., an L2, L3, L4, or other cache) that is located between an L1 cache and an LLC may be referred to herein as a mid-level cache. When a request misses in the L1 cache, the request may be sent to one or more mid-level caches. If the request misses in these caches, it may then be sent to the LLC 614.

In the embodiment depicted, the processor also includes cache controller 112, memory side sectored cache 102, memory side sectored prefetcher 106, miss handler 114, and memory controller 116. The processor may be coupled to system memory 104.

During operation, a core 602A, 602B, . . . or 602N may send a memory request (e.g., read request), via an L1 cache, to an L2 cache (and/or other mid-level cache positioned before the LLC). In various embodiments, a cache agent 612 may intercept a read request from an L1 cache (e.g., when data or an instruction to be used by a core is not found in the corresponding L1 cache, an L1 miss is considered to have occurred, and the L1 cache may subsequently send a request for the data or instruction to an L2 cache). If the read request hits the L2 cache, the L2 cache returns the data in the cache line that, e.g., matches a tag lookup. If the read request misses the L2 cache, then the read request is forwarded to the LLC (or the next mid-level cache and eventually to the LLC if the read request misses the mid-level cache(s)). If the read request misses in the LLC, the data is retrieved from cache 102 if the data is located in the cache. Otherwise the data is retrieved from system memory 104.

In various embodiments, the cache agents (or a subset thereof) may each include a separate instance of a CPU prefetcher. In other embodiments, one or more instances of a CPU prefetcher may may be located on the processor independent of a cache agent. A CPU prefetcher may request data to be filled into a cache of the processor (e.g., LLC 614 or a lower level cache) prior to the data being requested by a core.

I/O controller 624 may include logic for communicating data between the processor and I/O devices 626, which may refer to any suitable devices capable of transferring data to and/or receiving data from an electronic system, such as the processor. For example, an I/O device may be a network fabric controller; an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input device such as a monitor, printer, mouse, keyboard, or scanner; or other suitable device.

An I/O device 626 may communicate with I/O controller 624 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In various embodiments, I/O devices 626 coupled to the I/O controller 624 may be located off-chip (i.e., not on the same integrated circuit or die as a processor) or may be integrated on the same integrated circuit or die as a processor.

Although not depicted, a computing system including the processor may include and/or use a battery, renewable energy converter (e.g., solar power or motion-based energy), and/or power supply outlet connector and associated system to receive power, a display to output data provided by the processor, and/or a network interface allowing the processor to communicate over a network. In various embodiments, the battery, power supply outlet connector, display, and/or network interface may be communicatively coupled to the processor.

The figures below depict example computing systems in which the embodiments described above may be implemented. For example,

The figures below detail exemplary architectures and systems to implement embodiments of the above. For example, any of the processors and systems described below may include or be coupled to cache controller 112, prefetcher 106, and cache 102. In some embodiments, one or more hardware components and/or instructions described above are emulated as detailed below, or implemented as software modules.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures. Like reference numbers and designations in the various drawings indicate like elements.

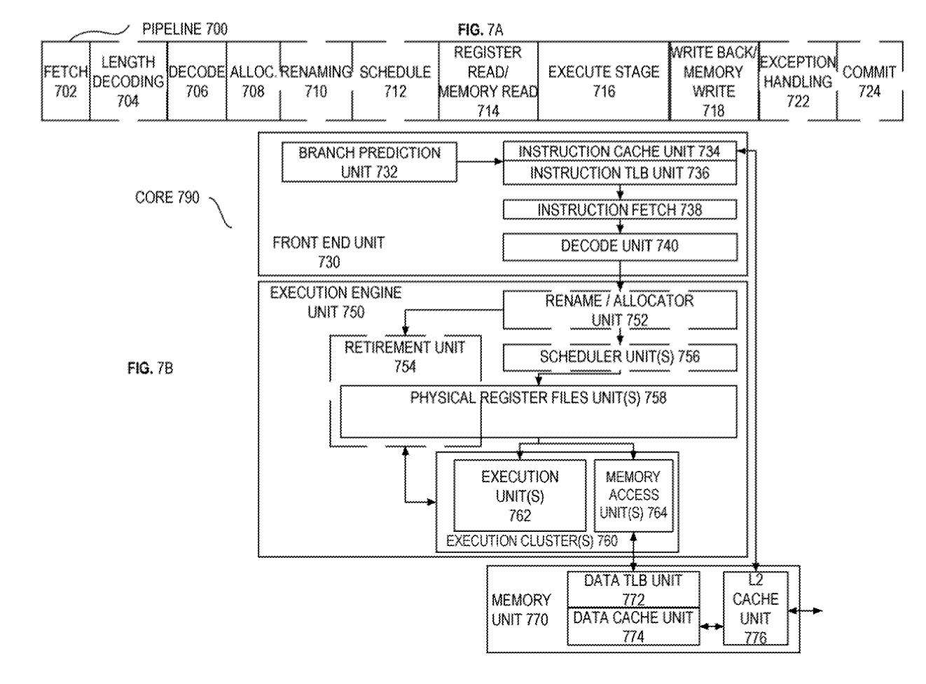

FIG. 7A is a block diagram illustrating both an exemplary in-order pipeline and an exemplary register renaming, out-of-order issue/execution pipeline according to embodiments of the disclosure. FIG. 7B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression and/or decompression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

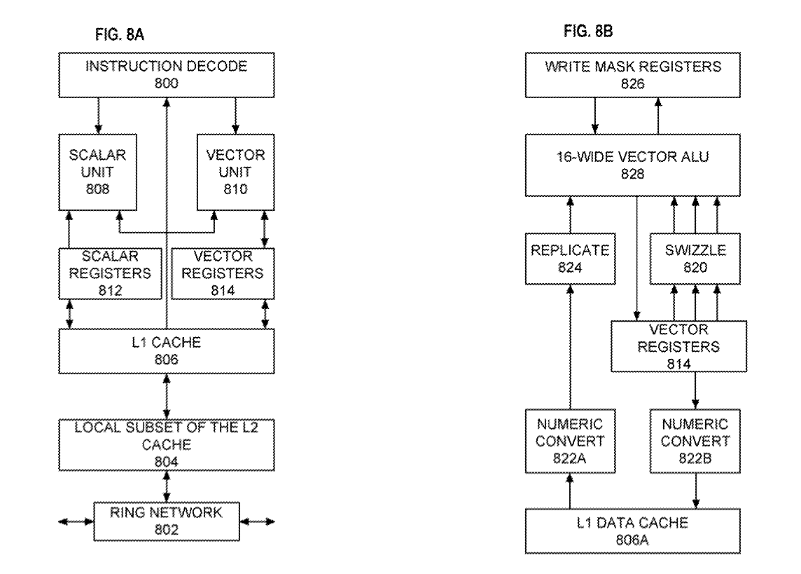

FIGS. 8A-B illustrate a block diagram of a more specific exemplary in-order core architecture, which core would be one of several logic blocks (potentially including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to various embodiments. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments may use a different approach (e.g., use a single register set or include a communication path that allow data to be transferred between the two register files without being written and read back).

The local subset of the L2 cache 804 is part of a global L2 cache that is divided into separate local subsets (in some embodiments one per processor core). Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip. In a particular embodiment, each ring data-path is 1012-bits wide per direction.

FIG. 8B is an expanded view of part of the processor core in FIG. 8A according to embodiments. FIG. 8B includes an L1 data cache 806A (part of the L1 cache 806), as well as more detail regarding the vector unit 810 and the vector registers 814. Specifically, the vector unit 810 is a 16-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input. Write mask registers 826 allow predicating resulting vector writes.

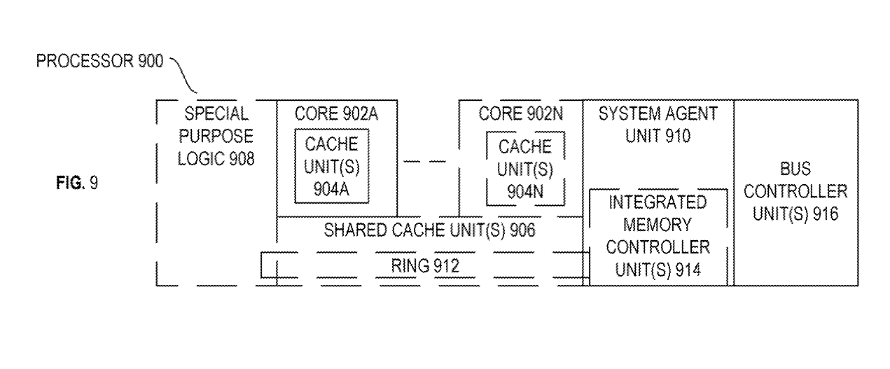

FIG. 9 is a block diagram of a processor 900 that may have more than one core, may have an integrated memory controller, and may have integrated graphics according to various embodiments. The solid lined boxes in FIG. 9 illustrate a processor 900 with a single core 902A, a system agent 910, and a set of one or more bus controller units 916; while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, or a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression and/or decompression engine, graphics processor, GPGPU (general purpose graphics processing unit), a high-throughput many integrated core (MIC) coprocessor (e.g., including 30 or more cores), embedded processor, or other fixed or configurable logic that performs logical operations. The processor may be implemented on one or more chips. The processor 900 may be a part of and/or may be implemented on one or more substrates using any of a number of process technologies, such as, for example, BiCMOS, CMOS, or NMOS.

In various embodiments, a processor may include any number of processing elements that may be symmetric or asymmetric. In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the special purpose logic (e.g., integrated graphics logic) 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902A-N.

In some embodiments, one or more of the cores 902A-N are capable of multi-threading. The system agent 910 includes those components coordinating and operating cores 902A-N. The system agent unit 910 may include for example a power control unit (PCU) and a display unit. The PCU may be or include logic and components needed for regulating the power state of the cores 902A-N and the special purpose logic 908. The display unit is for driving one or more externally connected displays.

The cores 902A-N may be homogenous or heterogeneous in terms of architecture instruction set; that is, two or more of the cores 902A-N may be capable of executing the same instruction set, while others may be capable of executing only a subset of that instruction set or a different instruction set.

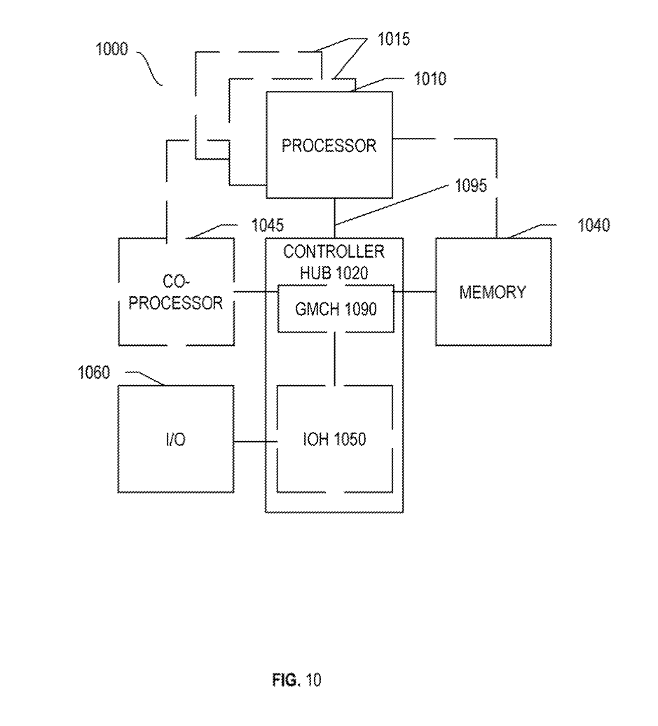

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable for performing the methods described in this disclosure. In general, a huge variety of systems or electronic devices capable of incorporating a processor and/or other execution logic as disclosed herein are generally suitable.

FIG. 10 depicts a block diagram of a system 1000 in accordance with one embodiment of the present disclosure. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips or the same chip); the GMCH 1090 includes memory and graphics controllers coupled to memory 1040 and a coprocessor 1045; the IOH 1050 couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 is a single chip comprising the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random access memory (DRAM), phase change memory (PCM), other suitable memory, or any combination thereof. The memory 1040 may store any suitable data, such as data used by processors 1010, 1015 to provide the functionality of computer system 1000. For example, data associated with programs that are executed or files accessed by processors 1010, 1015 may be stored in memory 1040. In various embodiments, memory 1040 may store data and/or sequences of instructions that are used or executed by processors 1010, 1015.

In at least one embodiment, the controller hub 1020 communicates with the processor(s) 1010, 1015 via a multi-drop bus, such as a frontside bus (FSB), point-to-point interface such as QuickPath Interconnect (QPI), or similar connection 1095.

In one embodiment, the coprocessor 1045 is a special-purpose processor, such as, for example, a high-throughput MIC processor, a network or communication processor, compression and/or decompression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, microarchitectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

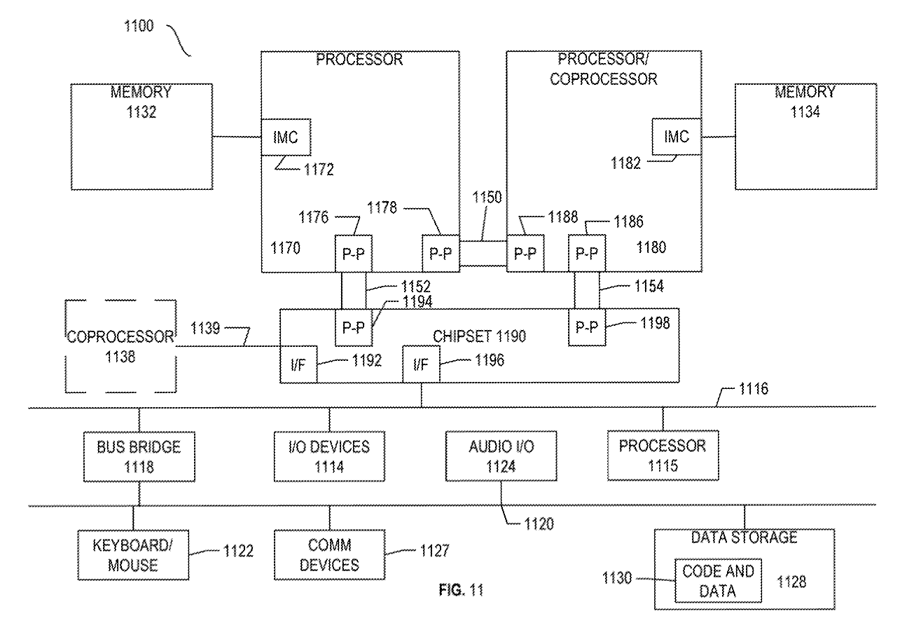

FIG. 11 depicts a block diagram of a first more specific exemplary system 1100 in accordance with an embodiment of the present disclosure. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the disclosure, processors 1170 and 1180 are respectively processors 1010 and 1015, while coprocessor 1138 is coprocessor 1045. In another embodiment, processors 1170 and 1180 are respectively processor 1010 and coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression and/or decompression engine, graphics processor, GPGPU, embedded processor, or the like.

A shared cache (not shown) may be included in either processor or outside of both processors, yet connected with the processors via a P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present disclosure is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are contemplated by this disclosure. For example, instead of the point-to-point architecture of FIG. 11, a system may implement a multi-drop bus or other such architecture.

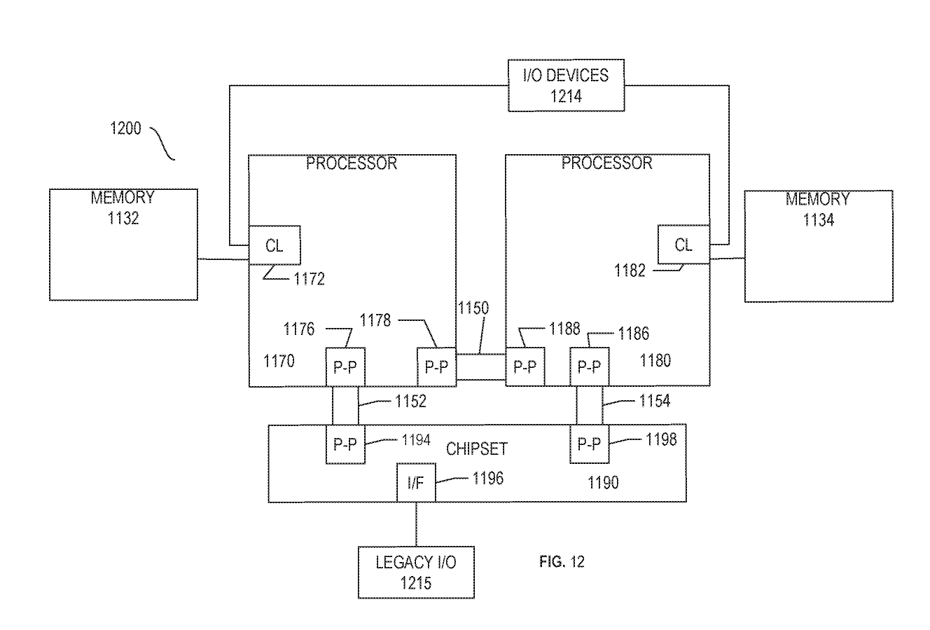

FIG. 12 depicts a block diagram of a second more specific exemplary system 1200 in accordance with an embodiment of the present disclosure. Similar elements in FIGS. 11 and 12 bear similar reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

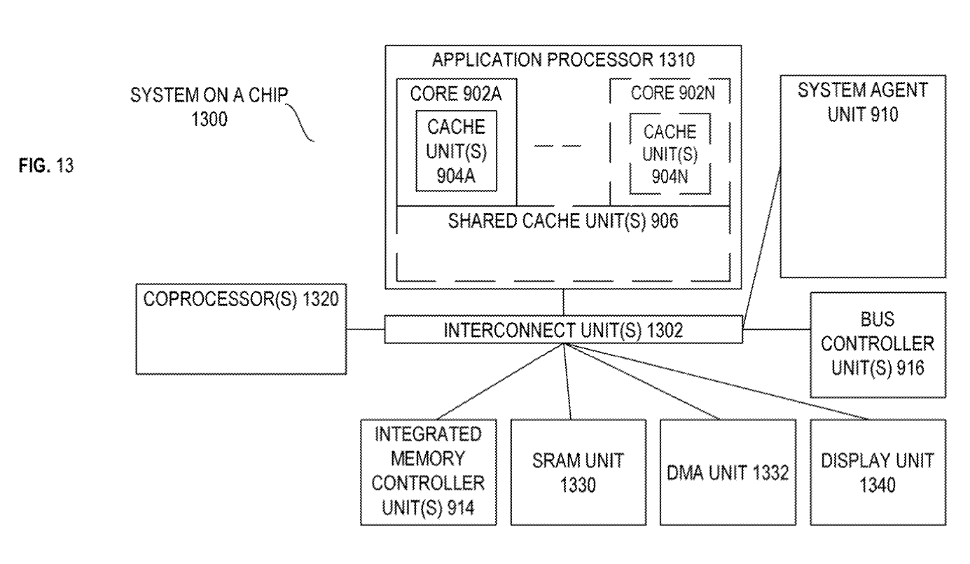

FIG. 13 depicts a block diagram of a SoC 1300 in accordance with an embodiment of the present disclosure. Similar elements in FIG. 9 bear similar reference numerals. Also, dashed lined boxes are optional features on more advanced SoCs. In FIG. 13, an interconnect unit(s) 1302 is coupled to: an application processor 1310 which includes a set of one or more cores 902A-N and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression and/or decompression engine, GPGPU, a high-throughput MIC processor, embedded processor, or the like.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

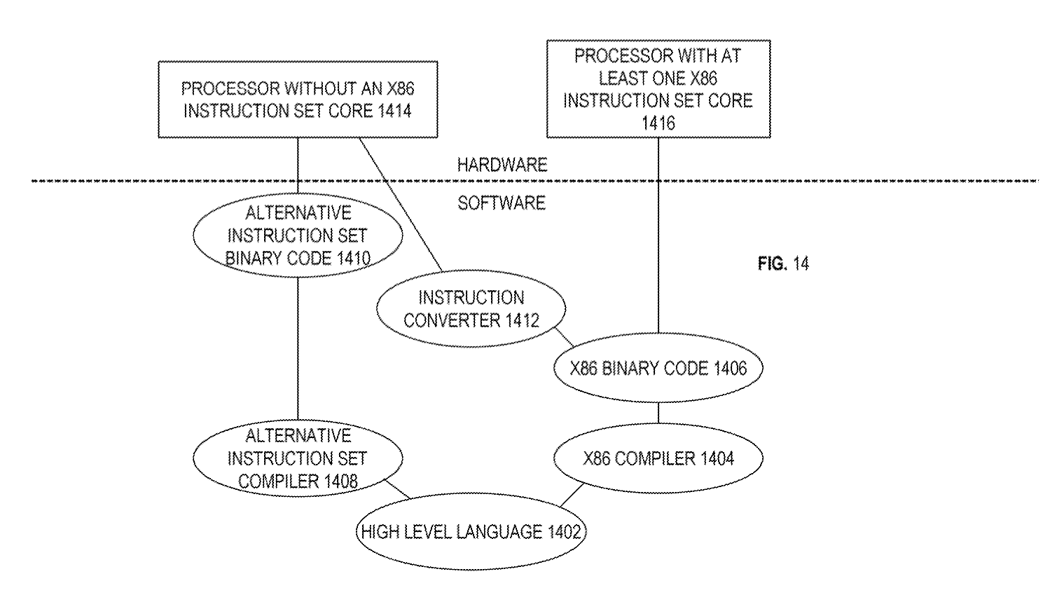

FIG. 14 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 14 shows a program in a high level language 1402 may be compiled using an x86 compiler 1404 to generate x86 binary code 1406 that may be natively executed by a processor with at least one x86 instruction set core 1416. The processor with at least one x86 instruction set core 1416 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1404 represents a compiler that is operable to generate x86 binary code 1406 (e.g., object code) that can, with or without additional linkage processing, be executed on the processor with at least one x86 instruction set core 1416. Similarly, FIG. 14 shows the program in the high level language 1402 may be compiled using an alternative instruction set compiler 1408 to generate alternative instruction set binary code 1410 that may be natively executed by a processor without at least one x86 instruction set core 1414 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1412 is used to convert the x86 binary code 1406 into code that may be natively executed by the processor without an x86 instruction set core 1414. This converted code is not likely to be the same as the alternative instruction set binary code 1410 because an instruction converter capable of this is difficult to make; however, the converted code will accomplish the general operation and be made up of instructions from the alternative instruction set. Thus, the instruction converter 1412 represents software, firmware, hardware, or a combination thereof that, through emulation, simulation or any other process, allows a processor or other electronic device that does not have an x86 instruction set processor or core to execute the x86 binary code 1406.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the manufacture of the described hardware.

In any representation of the design, the data representing the design may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

Thus, one or more aspects of at least one embodiment may be implemented by representative instructions stored on a machine-readable medium which represents various logic within the processor, which when read by a machine causes the machine to fabricate logic to perform the techniques described herein. Such representations, often referred to as “IP cores” may be stored on a non-transitory tangible machine readable medium and supplied to various customers or manufacturing facilities to load into the fabrication machines that manufacture the logic or processor.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In various embodiments, the language may be a compiled or interpreted language.

The embodiments of methods, hardware, software, firmware or code set forth above may be implemented via instructions or code stored on a machine-accessible, machine readable, computer accessible, or computer readable medium which are executable (or otherwise accessible) by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information therefrom.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Logic may be used to implement any of the functionality of the various components such as requestor 108, tag controller 110, prefetcher 106, cache controller 112, cache 102, miss handler 114, memory controller 116, system memory, controller 206, trackers 302, MSP controller 304, trigger 316, tracker selector 318, park counter 320, prefetch issuer 322, other component described herein, or any subcomponent of any of these components. “Logic” may refer to hardware, firmware, software and/or combinations of each to perform one or more functions. As an example, logic may include hardware, such as a micro-controller or processor, associated with a non-transitory medium to store code adapted to be executed by the micro-controller or processor. Therefore, reference to logic, in one embodiment, refers to the hardware, which is specifically configured to recognize and/or execute the code to be held on a non-transitory medium. Furthermore, in another embodiment, use of logic refers to the non-transitory medium including the code, which is specifically adapted to be executed by the microcontroller to perform predetermined operations. And as can be inferred, in yet another embodiment, the term logic (in this example) may refer to the combination of the hardware and the non-transitory medium. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components, which may be implemented by, e.g., transistors. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Often, logic boundaries that are illustrated as separate commonly vary and potentially overlap. For example, first and second logic may share hardware, software, firmware, or a combination thereof, while potentially retaining some independent hardware, software, or firmware.

Use of the phrase ‘to’ or ‘configured to,’ in one embodiment, refers to arranging, putting together, manufacturing, offering to sell, importing and/or designing an apparatus, hardware, other logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, hardware, other logic, and/or element designed in such a way to enable use of the apparatus, hardware, other logic, and/or element in a specified manner. Note as above that use of to, capable to, or operable to, in one embodiment, refers to the latent state of an apparatus, hardware, other logic, and/or element, where the apparatus, hardware, other logic, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

In at least one embodiment, a processor comprises a prefetcher comprising a plurality of trackers, a tracker of the plurality of trackers to store a prefetch mask to indicate which cache lines of a sector of a sectored cache have been prefetched from a system memory to the sectored cache; and a prefetch issuer comprising circuitry, the prefetch issuer to generate a prefetch request to prefetch cache lines of the sector of the sectored cache from the system memory into the sectored cache based on a prefetch confidence metric associated with the sector of the sectored cache.

In an embodiment, the prefetcher (e.g., via tracker updater 324) is to increase the prefetch confidence metric associated with the sector responsive to a request for a cache line that was previously prefetched as indicated by the prefetch mask. In an embodiment, the prefetcher further comprises a trigger comprising circuitry to selectively enable prefetching by the prefetcher based on a metric indicating a utilization level of the system memory. In an embodiment, the trigger comprises a counter that is to increment in response to a request to the system memory and to decrement at a rate corresponding to a bandwidth of the system memory. In an embodiment, the trigger is to limit prefetching to a first rate responsive to a first value of the counter, to further limit prefetching responsive to a second value of the counter, and to disable prefetching responsive to a third value of the counter. In an embodiment, the trigger is to selectively enable prefetching by the prefetcher based on an occupancy of a request queue that is to store data requests to be sent to the system memory. In an embodiment, the prefetcher further comprises a park counter, the park counter to cause a minimum number of consecutive prefetches to be issued by the prefetcher for the sector. In an embodiment, the prefetcher is to be reset and to issue one or more prefetches for a different sector corresponding to a different tracker in response to the park counter crossing a threshold value. In an embodiment, the sectored cache is to cache data of the system memory for a requestor, wherein the requestor is to request data in response to a determination that a last level cache associated with the requestor does not store the data. In an embodiment, the prefetcher is to access a lookup result generated by a controller that is to direct a request for data to one of the system memory or the sectored cache based on whether the data is located in the sectored cache; and update the tracker based on the lookup result.

In at least one embodiment, a method comprises allocating a plurality of trackers of a prefetcher, a tracker of the plurality of trackers to store a prefetch mask to indicate which cache lines of a sector of a sectored cache have been prefetched from a system memory to the sectored cache; and generating, by a prefetch issuer, a prefetch request to prefetch cache lines of the sector of the sectored cache from the system memory into the sectored cache based on a prefetch confidence metric associated with the sector of the sectored cache.

In an embodiment, a method further comprises increasing, by the prefetcher, the prefetch confidence metric associated with the sector responsive to a request for a cache line that was previously prefetched as indicated by the prefetch mask. In an embodiment, a method further comprises selectively enabling, by a trigger of the prefetcher, prefetching by the prefetcher based on a metric indicating a utilization level of the system memory. In an embodiment, a method further comprises incrementing a counter of the trigger in response to a request to the system memory and decrementing the counter at a rate corresponding to a bandwidth of the system memory. In an embodiment, a method further comprises limiting prefetching to a first rate responsive to a first value of the counter, further limiting prefetching responsive to a second value of the counter, and disabling prefetching responsive to a third value of the counter. In an embodiment, a method further comprises selectively enabling, by the trigger, prefetching by the prefetcher based on an occupancy of a request queue that is to store data requests to be sent to the system memory. In an embodiment, a method further comprises causing, by a park counter, a minimum number of consecutive prefetches to be issued by the prefetcher for the sector. In an embodiment, a method further comprises resetting the park counter and issuing one or more prefetches for a different sector corresponding to a different tracker in response to the park counter crossing a threshold value. In an embodiment, a method further comprises caching data of the system memory in the sectored cache and requesting data from the sectored cache in response to a determination that a last level cache of a requestor does not store the data. In an embodiment, a method further comprises accessing a lookup result generated by a controller that is to direct a request for data to one of the system memory or the sectored cache based on whether the data is located in the sectored cache; and updating the tracker based on the lookup result.

In at least one embodiment, a system comprises a system memory; a sectored cache to cache data of the system memory; and a prefetcher comprising a plurality of trackers, a tracker of the plurality of trackers to store a prefetch mask indicating which cache lines of a sector of a sectored cache have been prefetched from a system memory to the sectored cache; and a prefetch issuer comprising circuitry, the prefetch issuer to generate a prefetch request to prefetch cache lines of the sector of the sectored cache from the system memory into the sectored cache based on a prefetch confidence metric associated with the sector of the sectored cache.

In an embodiment, a system further comprises a memory controller to request data from the system memory responsive to the prefetch request. In an embodiment, a system further comprises a network interface controller to receive data over a network and send the data towards the system memory. In an embodiment, a system further comprises a processor core, an L1 cache, an L2 cache, a last level cache, and a tag controller, wherein the tag controller is to receive a data request of the processor core responsive to a cache miss in the last level cache and determine whether data requested is located in the sectored cache. In an embodiment, the prefetcher is to increase the prefetch confidence metric associated with the sector in response to a request for a cache line that has been previously prefetched as indicated by the prefetch mask. In an embodiment, the prefetcher further comprises a trigger comprising circuitry to selectively enable prefetching by the prefetcher based on a metric indicating a utilization level of the system memory. In an embodiment, the prefetcher further comprises a park counter, the park counter to cause a minimum number of consecutive prefetches to be issued by the prefetcher for the sector.

In at least one embodiment, a non-transitory machine readable storage medium including instructions stored thereon, the instructions when executed by a machine to cause the machine to allocate a plurality of trackers, a tracker of the plurality of trackers to store a prefetch mask indicating which cache lines of a sector of a sectored cache have been prefetched from a system memory to the sectored cache; and issue a prefetch request to prefetch cache lines of the sector of the sectored cache from the system memory into the sectored cache based on a prefetch confidence metric associated with the sector of the sectored cache.

In an embodiment, the instructions when executed cause the machine to increase the prefetch confidence metric associated with the sector in response to a request for a cache line that has been previously prefetched as indicated by the prefetch mask. In an embodiment, the instructions when executed cause the machine to selectively enable prefetching by the prefetcher based on a metric indicating a utilization level of the system memory.

In at least one embodiment, a system comprises means for allocating a plurality of trackers of a prefetcher, a tracker of the plurality of trackers to store a prefetch mask to indicate which cache lines of a sector of a sectored cache have been prefetched from a system memory to the sectored cache; and means for generating a prefetch request to prefetch cache lines of the sector of the sectored cache from the system memory into the sectored cache based on a prefetch confidence metric associated with the sector of the sectored cache.

In an embodiment, a system further comprises means for increasing the prefetch confidence metric associated with the sector responsive to a request for a cache line that was previously prefetched as indicated by the prefetch mask. In an embodiment, a system further comprises means for selectively enabling prefetching based on a metric indicating a utilization level of the system memory. In an embodiment, a system further comprises means for incrementing a counter of the trigger in response to a request to the system memory and decrementing the counter at a rate corresponding to a bandwidth of the system memory. In an embodiment, a system further comprises means for limiting prefetching to a first rate responsive to a first value of the counter, further limiting prefetching responsive to a second value of the counter, and disabling prefetching responsive to a third value of the counter. In an embodiment, a system further comprises means for selectively enabling prefetching based on an occupancy of a request queue that is to store data requests to be sent to the system memory. In an embodiment, a system further comprises means for operating a park counter to cause a minimum number of consecutive prefetches to be issued for the sector. In an embodiment, a system further comprises means for resetting the park counter and issuing one or more prefetches for a different sector corresponding to a different tracker in response to the park counter crossing a threshold value. In an embodiment, a system further comprises means for caching data of the system memory in the sectored cache and means for requesting data from the sectored cache in response to a determination that a last level cache of a requestor does not store the data. In an embodiment, a system further comprises means for accessing a lookup result generated by a controller that is to direct a request for data to one of the system memory or the sectored cache based on whether the data is located in the sectored cache; and means for updating the tracker based on the lookup result.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. A processor comprising:
a prefetcher comprising:
a plurality of trackers, a tracker of the plurality of trackers to store a prefetch mask to indicate which cache lines of a sector of a sectored cache have been prefetched from a system memory to the sectored cache; and
a prefetch issuer comprising circuitry, the prefetch issuer to generate a prefetch request to prefetch one or more cache lines of the sector of the sectored cache from the system memory into the sectored cache based on a prefetch confidence metric associated with the sector of the sectored cache.

2. The processor of claim 1, wherein the prefetcher is to increase the prefetch confidence metric associated with the sector responsive to a request for a cache line that was previously prefetched as indicated by the prefetch mask.

3. The processor of claim 1, wherein the prefetcher further comprises a trigger comprising circuitry to selectively enable prefetching by the prefetcher based on a metric indicating a utilization level of the system memory.

4. The processor of claim 3, wherein the trigger comprises a counter that is to increment in response to a request to the system memory and to decrement at a rate corresponding to a bandwidth of the system memory.

5. The processor of claim 3, wherein the trigger is to limit prefetching to a first rate responsive to a first value of the counter, to further limit prefetching responsive to a second value of the counter, and to disable prefetching responsive to a third value of the counter.

6. The processor of claim 3, wherein the trigger is to selectively enable prefetching by the prefetcher based on an occupancy of a request queue that is to store data requests to be sent to the system memory.

7. The processor of claim 1, wherein the prefetcher further comprises a park counter, the park counter to cause a minimum number of consecutive prefetches to be issued by the prefetcher for the sector.

8. The processor of claim 7, the prefetcher to be reset and to issue one or more prefetches for a different sector corresponding to a different tracker in response to the park counter crossing a threshold value.

9. The processor of claim 1, wherein the sectored cache is to cache data of the system memory for a requestor, wherein the requestor is to request data in response to a determination that a last level cache associated with the requestor does not store the data.

10. The processor of claim 1, wherein the prefetcher is to:
access a lookup result generated by a controller that is to direct a request for data to one of the system memory or the sectored cache based on whether the data is located in the sectored cache; and
update the tracker based on the lookup result.

11. A system comprising:
a system memory;
a sectored cache to cache data of the system memory; and
a prefetcher comprising:
a plurality of trackers, a tracker of the plurality of trackers to store a prefetch mask indicating which cache lines of a sector of a sectored cache have been prefetched from a system memory to the sectored cache; and
a prefetch issuer comprising circuitry, the prefetch issuer to generate a prefetch request to prefetch one or more cache lines of the sector of the sectored cache from the system memory into the sectored cache based on a prefetch confidence metric associated with the sector of the sectored cache.

12. The system of claim 11, further comprising a memory controller to request data from the system memory responsive to the prefetch request.

13. The system of claim 11, further comprising a network interface controller to receive data over a network and send the data towards the system memory.

14. The system of claim 11, further comprising a processor core, an L1 cache, an L2 cache, a last level cache, and a tag controller, wherein the tag controller is to receive a data request of the processor core responsive to a cache miss in the last level cache and determine whether data requested is located in the sectored cache.

15. The system of claim 5, wherein the prefetcher is to increase the prefetch confidence metric associated with the sector in response to a request for a cache line that has been previously prefetched as indicated by the prefetch mask.

16. The system of claim 11, wherein the prefetcher further comprises a trigger comprising circuitry to selectively enable prefetching by the prefetcher based on a metric indicating a utilization level of the system memory.

17. The system of claim 11, wherein the prefetcher further comprises a park counter, the park counter to cause a minimum number of consecutive prefetcher to be issued by the prefetcher for the sector.

18. A non-transitory machine readable storage medium having instructions stored thereon, the instructions when executed by a machine to cause the machine to:
allocate a plurality of trackers, a tracker of the plurality of trackers to store a prefetch mask indicating which cache lines of a sector of a sectored cache have been prefetched from a system memory to the sectored cache; and
issue a prefetch request to prefetch cache lines of the sector of the sectored cache from the system memory into the sectored cache based on a prefetch confidence metric associated with the sector of the sectored cache.

19. The medium of claim 18, the instructions when executed to cause the machine to increase the prefetch confidence metric associated with the sector in response to a request for a cache line that has been previously prefetched as indicated by the prefetch mask.

20. The medium of claim 18, the instructions when executed to cause the machine to selectively enable prefetching by the prefetcher based on a metric indicating a utilization level of the system memory.

21. The processor of claim 1, wherein the tracker of the plurality of trackers is further to store a valid mask to indicate which cache lines of the sector are valid in the sectored cache.

22. The processor of claim 1, wherein the processor further comprises an additional prefetcher to prefetch data into a cache that is a lower level cache than the sectored cache and wherein the tracker is updated based on one or more requests made by the additional prefetcher.
